(19) United States
(12) Patent Application Publication
(10) Pub. No.: US 2008/0091511 A1
(43) Pub. Date: Apr. 17, 2008

(54) Method and system for registering, credentialing, rating, and/or cataloging businesses, organizations, and individuals on a communications network

(76) Inventors: John Andrew Monin JR., Atlanta, GA (US); Joseph Stephen Katzen, Richmond, VA (US); Andrew Joseph Somoza, Atlanta, GA (US); Gilbert Benton JR., Alpharatta, GA (US)

Correspondence Address: Charles Peeler, PO Box 7, Albany, GA, 31702, US

(21) Appl. No.: 11/705,395

(22) Filed: Feb. 12, 2007

Related U.S. Application Data
(60) Provisional application No. 60/766,794, filed on Feb. 12, 2006.

(51) Int. Cl. G06F 17/30; G06Q 30/00; G06Q 40/00

(52) U.S. Cl. 705/10; 705/34; 705/40

(57) ABSTRACT

A method and system for registering, credentialing, rating, trending, monitoring and cataloging businesses, organizations, and individuals. The applicant business, organization, or individual clicks to a computer server to begin the registration process for the benefit of the applicant and its customer. The server system receives the request for registration and requests contact information, product category codes, and other details and payment information from the applicant. The applicant's details are then used to aggregate other electronic records to determine applicant's suitability. The details and records are then rated based on predetermined thresholds to provide an acceptability score for the applicant. The applicant may return to the computer server to log-in to view and edit the applicant's details pursuant to a subscription agreement. The customer may then also log-in to view all details of registered vendors, sorted according to various options. In the preferred embodiment of the invention, the internet acts as the computer network described.

### RELATED APPLICATIONS

This application claims priority to provisional patent application No. 60/766794 entitled “Method and system for registering, credentialing, rating, and/or cataloging businesses, organizations, and individuals on a communications network” filed Feb. 12, 2006 in the name of John Monin, et al.

### TECHNICAL FIELD

The present invention relates to a system and method for managing existing and new business relationships, and more particularly to a system and method for registering, credentialing, rating, monitoring, and cataloging businesses, organizations, and individuals utilizing computer networks such as the Internet.

### BACKGROUND OF THE INVENTION

Increased globalization and the proliferation of suppliers and service providers (collectively, “vendors”) have in recent years provided an unparalleled variety of choices for businesses and consumers. These choices encompass both various price and quality points among commodities as well as unique and newly invented services and products. Increased globalization creates situations where businesses may not have longstanding relationships with suppliers used by that business. This is putting businesses, retailers and other buyers of products and services (collectively, “buying organizations”) in the precarious position of wanting access to this new wealth of options but lacking a system in place to manage these suppliers and service providers.

Merchandisers, procurement specialists, and human-resources managers (collectively, “buyers”) are increasingly inundated by thousands of unsolicited telephone call and email introductions (collectively, “cold-calls”) from new and existing vendors. This often requires a large dedicated staff devoted to receiving, routing, and managing these cold-calls and the associated relationships. Unfortunately, many of these new vendors are interested in selling products/services that do not immediately appeal to the buying organization for a variety of reasons: subjective undesirability, timing inconsistencies between the vendors and members of the buying organization, incompatibility with existing contractual relationships, budgeting concerns, etc. Nonetheless, common existing procedures generally necessitate that each and every vendor communicate with a buyer to discuss product/service offerings and vendor details, requiring a considerable devotion of time and resources to desirable and undesirable vendors.

Additionally, once a buyer has determined that there may be an interest in procuring the products/services provided by the vendor, traditional non-standardized processes generally predominate to handle the resulting vendor and product/service details including (among other data points) contact information, references, vendor/product/service descriptions, sales representative data, and process functionalities (such as electronic ordering enablement). Even within a single buying organization, experience indicates that different buyers manage this information in different ways including (among other methods) handwritten notes, files of brochures, computer spreadsheets, and electronic mail. The result of this is a recognized difficulty in locating histories of vendor-buyer contact, finding vendors to support business interests determined later, resuming relationships between the buying organization and a vendor after a buyer leaves the company or changes departments, and a common reliance on the imperfect memory of buyers to maintain buyer-vendor relationships.

Even as the difficulties in locating and managing the enormous amount of data inherent in these processes become apparent, buying organizations are still left without any consistent method to gauge the relative benefits of certain vendors over others or to inexpensively and easily independently validate information and guarantees suggested by the vendor sales representatives. The result is that buying organizations are often not informed of concerns including (among others) incorrect address information, poor credit, litigiousness, financial problems, labor practices, anti-social behavior, and public-relation gaffes.

A number of companies have existed for several years that have managed registration and credentialing for organizations interested in attracting and verifying vendors. In the field of diversity credentialing, such entities include CVM™, Mid-America Consulting group™ d/b/a Supplier Gateway™, and Austin-Tetra™. After one of these diversity credentialing companies has partnered with an organization, any vendors interested in participating in the organization's preferential diversity program would be required to register their name and product categories and select the “diverse” group of which they are a member (including minority-owned businesses, female-owned businesses, and disabled veteran-owned businesses). From this, the organization may then browse a database of registered “diverse” vendors to confirm their diversity status, product category offerings, and contact information. In the current implementations of the credentialing products offered by these companies, the subscribing organization pays a fee for the use of the product by it and its vendors.

Additionally, a number of data aggregators have operated for a number of years to collect, sort, and distribute credit and public records of individuals and businesses. The most significant companies in this market are Choicepoint™, Experian™, and Dun & Bradstreet™. Each of these companies offer reports detailing (in various forms) the legal and credit histories of the requested subjects in addition to electronic verification of existence and contact information. These companies base their business model on providing single reports for a fee paid by the requesting organization.

There has also been developed a “supply chain verification service” by Browz, LC™. After a buying organization partners with Browz, any vendors for whom it needs compliance data would be required to register and pay an annual fee. As part of this, any compliance documentation a member of the buying organization requested of the vendor may be submitted in electronic form through the system. The documentation provided by the vendors is then verified by Browz personnel through various means with the results posted in a one-time report for a member of the buying organization to view.

### SUMMARY OF THE INVENTION

The present invention provides a method and system for registering, credentialing, rating, monitoring, trending and cataloging businesses, organizations, and individuals using a communications network such as the internet and world-wide web (“WWW”). A vendor representative is provided a link from a buying organization web site or is otherwise referred to an application server in order to register. Personal and organizational information and listings of sales categories for the vendor and the representative are collected using computer interface techniques and submitted to the server through a website or closed network portal.

The vendor information is used to retrieve details from third-party sources including, in one implementation, public records, credit information, and government watch-lists. The entered data, in conjunction with the information retrieved from third-parties is scored using a customized rating tabulation to provide a rating indicator summarizing the vendor's acceptability to the buying organization. Subsets of the data are then available for vendor and customer representatives to view by returning to the application server and logging in. In particular, buyers may locate desirable vendors of particular goods and services through searches or browsing techniques.

### BRIEF DESCRIPTION OF THE DRAWINGS

FIGS. 1A-1E illustrate embodiments of the registration, cataloging, and data viewing system of the present invention.

FIGS. 2A-2B illustrate an embodiment of the vendor registration and log-in processes of the present invention.

FIG. 3A is a block diagram illustrating an embodiment of the data-entry processes of the present invention for a previously unregistered vendor.

FIG. 3B is a block diagram illustrating an embodiment of the data-entry processes of the present invention for a previously registered vendor.

FIG. 3C is a block diagram illustrating an update of a vendor's insurance information.

FIG. 3D is a block diagram illustrating an update of a vendor's profile with information received from a third party database.

FIG. 3E is a block diagram illustrating searching of third party databases for information related to a vendor and updating a vendor's profile with such information.

FIG. 4 is a block diagram illustrating an embodiment of the data entry, credentialing and rating process of the present invention.

FIG. 5 is a state diagram illustrating the various active and inactive statuses a vendor may hold during and after the registration process of the present invention.

FIG. 6A depicts a screen shot of one embodiment of the present invention illustrating various fields utilized in the scoring system of the present invention for a hypothetical vendor company.

FIG. 6B depicts a screen shot of one embodiment of the present invention illustrating various fields utilized in the scoring system of the present invention for a hypothetical vendor representative.

FIG. 7 represents an example of a badge generated by the system to assist with on-premises visits from vendor representatives.

### DETAILED DESCRIPTION OF THE INVENTION

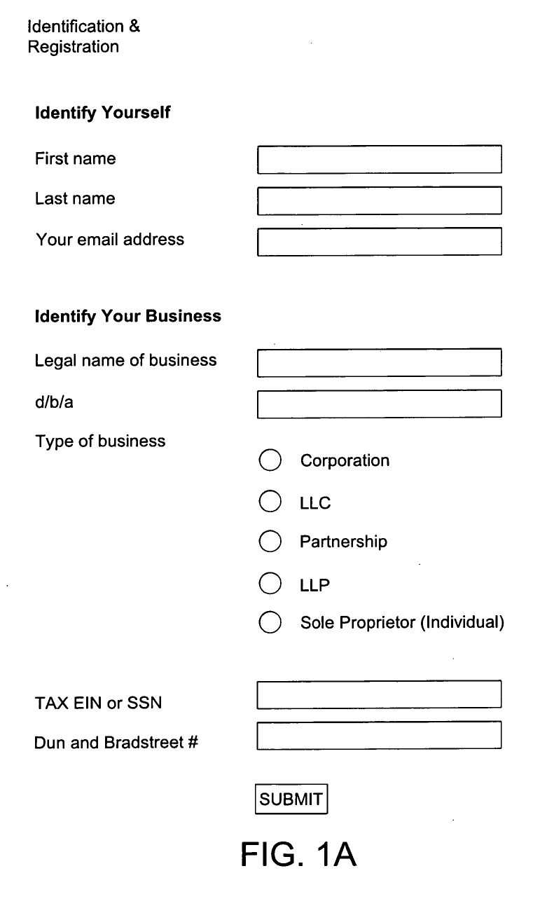

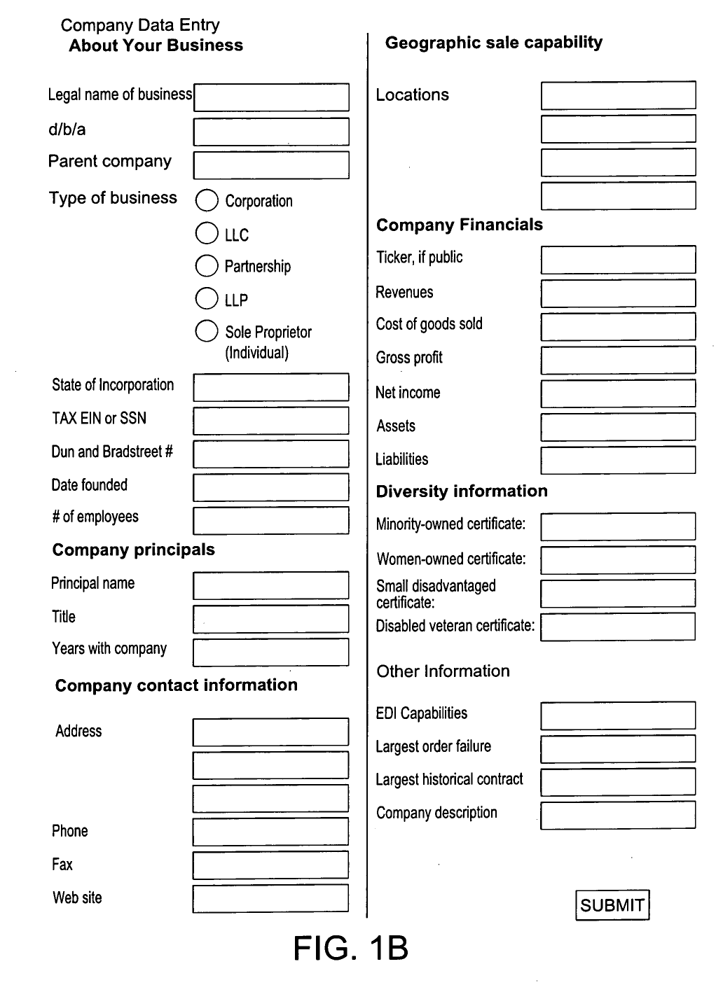

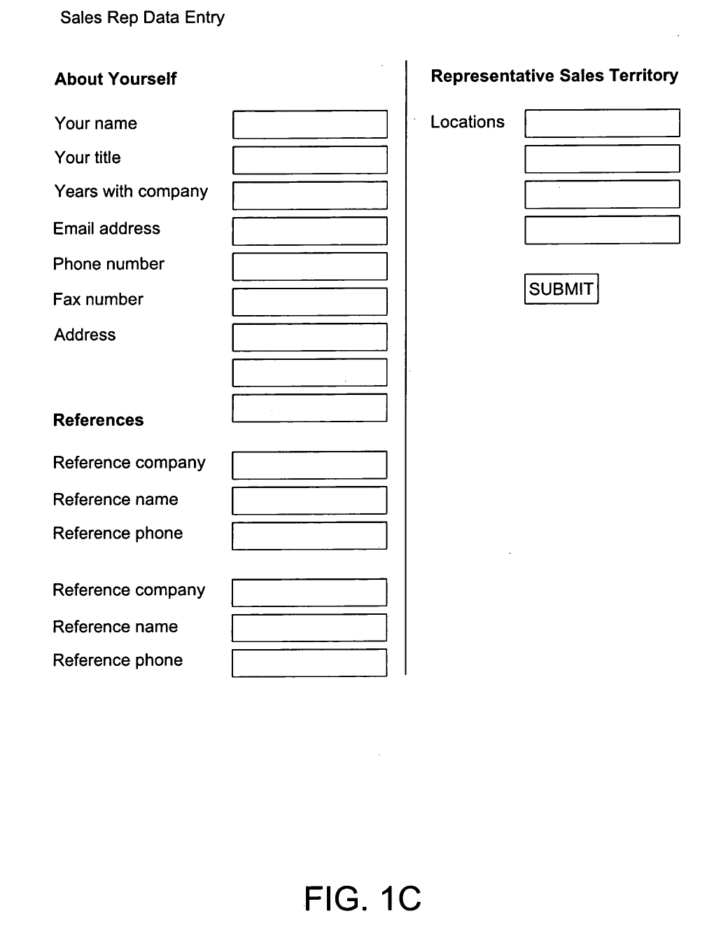

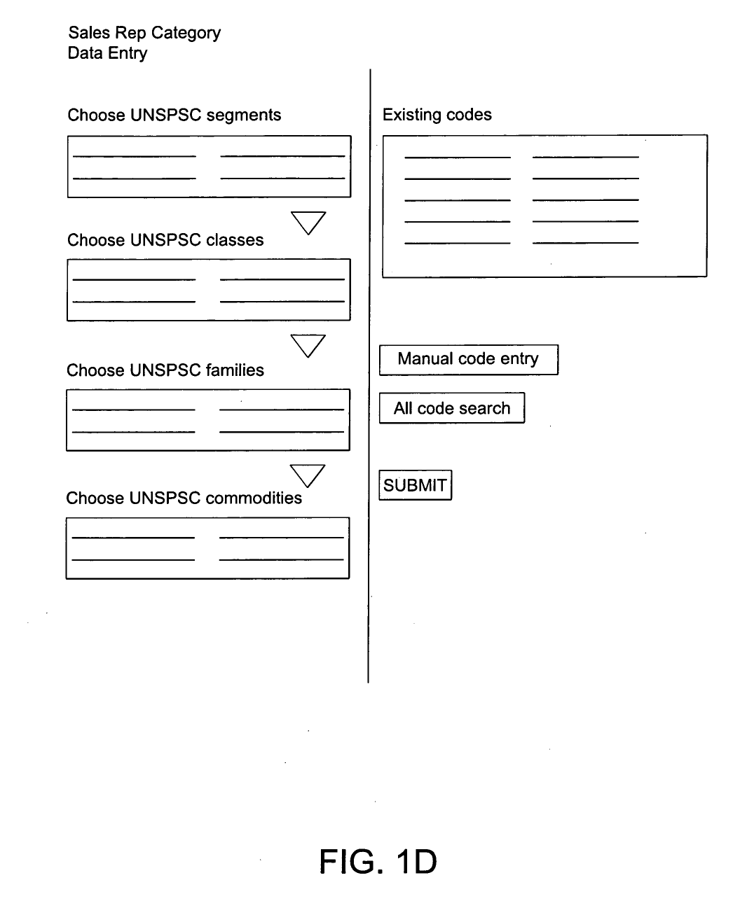

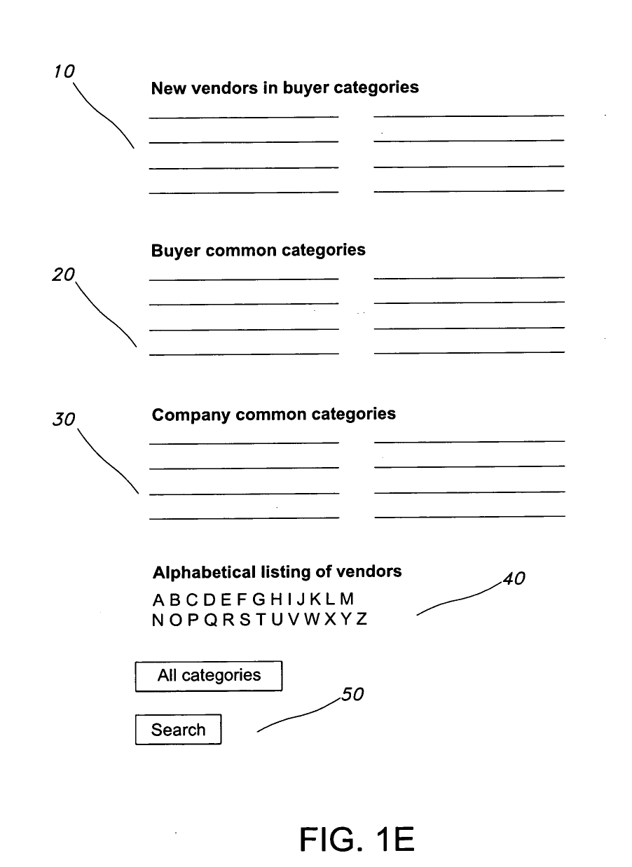

Referring now to the figures wherein like references refer to like elements across the several figures, the present invention provides a method and system for registering, credentialing, rating, monitoring, trending and cataloging businesses, organizations, and individuals on a communications network or computer. The present invention simplifies and improves the process of vendors showing interest in providing products/services to a buying organization and the subsequent selecting of vendors by the same buying organization as well as the monitoring of current vendors. In one embodiment, the vendor representative who desires to sell his products/services to the buying organization, from the web site of the buying organization, clicks a link to transfer the vendor representative's view to the server of the present invention. Alternatively, the vendor representative, referred by a member of the buying organization or an agent thereof by electronic or postal mail or by phone or similar method, enters the specific server locator address of the present invention into the representative's web browser or fills out a paper form and faxes or mails that form with answers to a clearinghouse. As set forth in FIGS. 1A-1C, if an electronic option is chosen, the vendor enters the vendor's personal identifying information (to include business and business representative information). Such information may include, without limitation, vendor representative name, email, phone number, business name, tax id, website, diversity, references, and other information as may be of interest to a particular buying organization.

As set forth in FIG. 1D, the vendor representative then enters product and services information such as recognized UNSPSC information corresponding to the goods and/or services offered by the vendor. As reflected in FIG. 1E, this information is available to buying organizations so as to allow buying organizations to view new vendors registered in UNSPSC categories of interest to a particular buyer (10), a listing of categories the buyer and vendor have in common (20), and list of categories in which a buying organization may provide goods and services consumed by a vendor (30). The buying organization may also view a list of all registered vendors (40) and may perform various searches to obtain desired information (50).

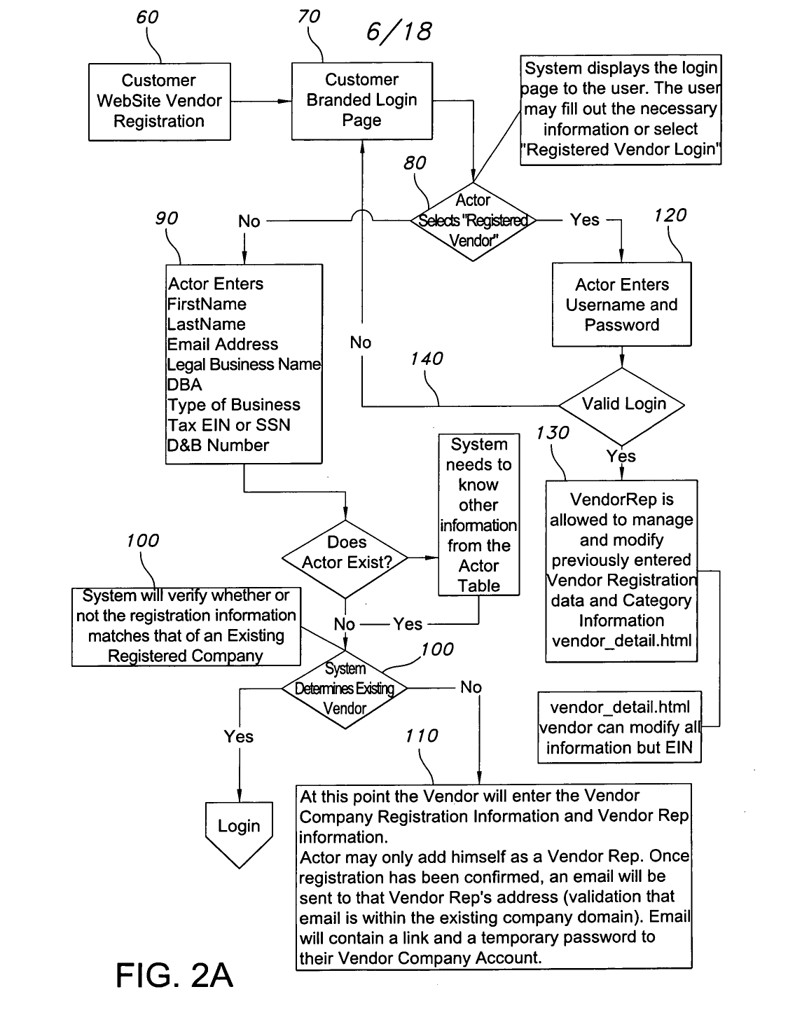

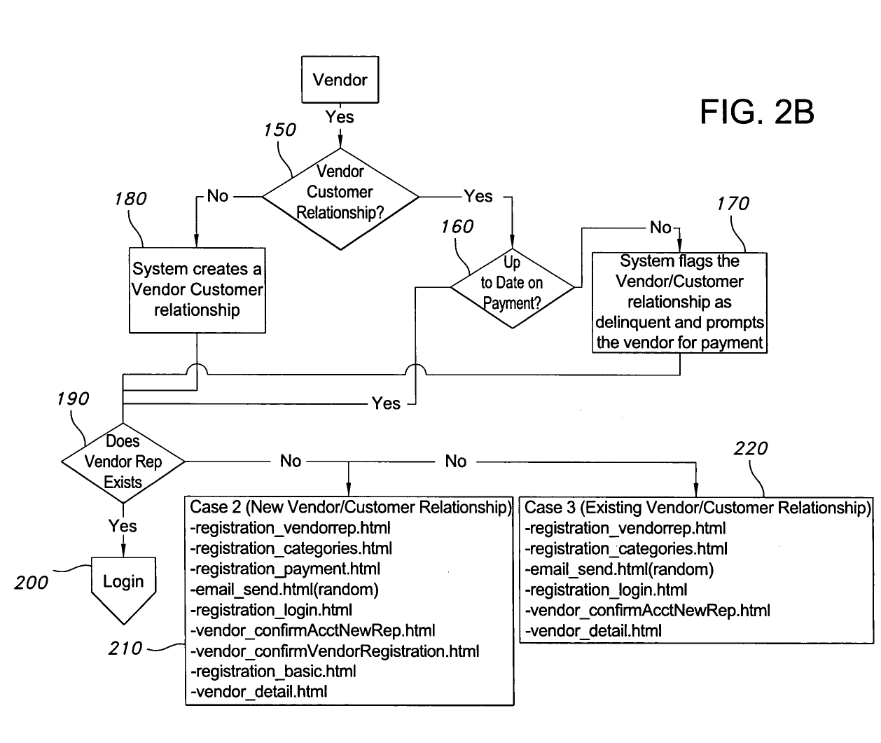

As set forth in FIG. 2A, a vendor representative visits a buying organization's website (sometimes referred to as a customer website) and enters the vendor registration webpage (60). The vendor is then directed to a vendor login page that is branded like the buying organization home page (70). The login page, however, is housed on the server of the present invention. At the vendor login page, the vendor is asked whether the vendor is currently registered (80). If the vendor indicates that it is not currently registered, the vendor is prompted to provide registration information (90), such as the information set forth in FIGS. 1A-1D. To minimize the possibility of double registration, the system of the present invention determines whether the vendor is, in fact, previously registered (100). If not, the vendor is prompted to register with the system by providing information requested by the system. After registration has been confirmed, an email is sent to the vendor representative containing a link and temporary password to the vendor's account within the system (110).

If at login the vendor indicates that it is currently registered, the vendor is prompted to enter user name and password (120). If login information is verified, the vendor is allowed access to manage and/or update registration information (130). If login is invalid, vendor is returned to login page (140).

It is contemplated by the present invention that a vendor in the database of registered vendors may have a relationship with one or more subscribing buying organizations. As set forth in FIG. 2B, following login it is determined whether a registered vendor has an existing relationship with a targeted buying organization (150). If yes, the system determines whether the vendor's payment responsibilities to the system of the present invention are current (160). If not, the system prompts the vendor for payment (170). If a relationship between a registered vendor and subscribing buying organization does not exist, the system creates the relationship (180). The system next determines whether a particular vendor representative is registered in the system (190). If yes, the vendor representative is granted login for management and updating of vendor account information (200). If a relationship does not exist between the vendor and buying organization, the system creates a relationship depending on whether the vendor is currently registered in the system (and perhaps has relationships with other buying organizations) (220) or is a new vendor to the system (210).

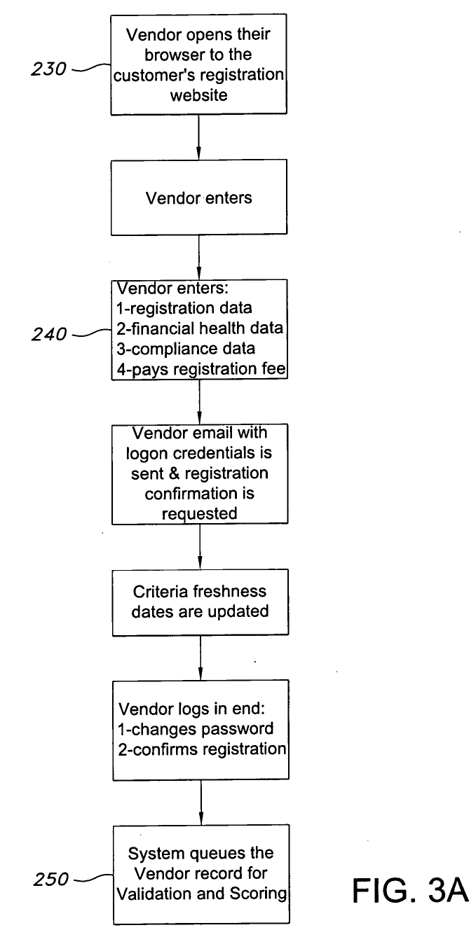

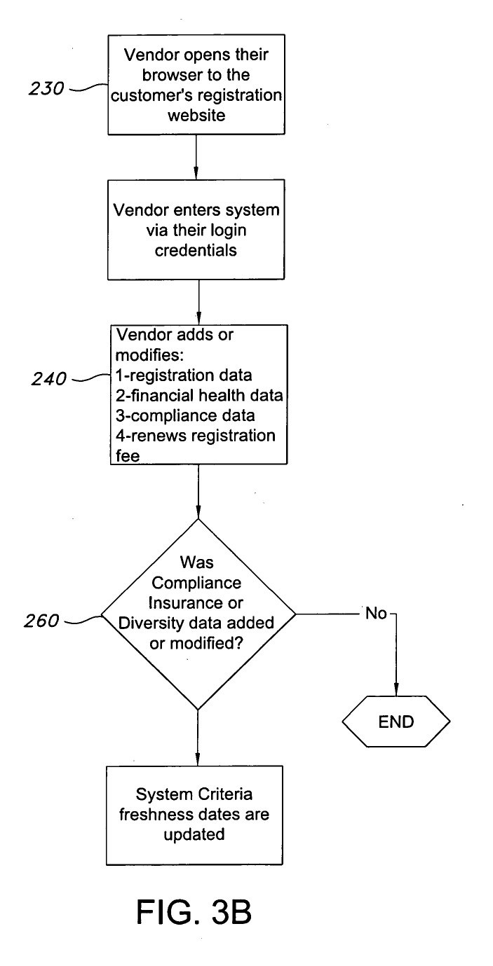

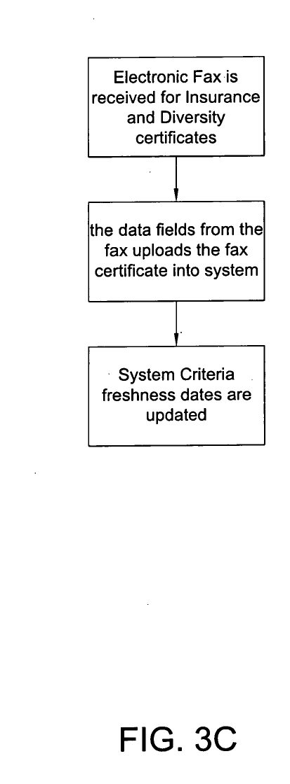

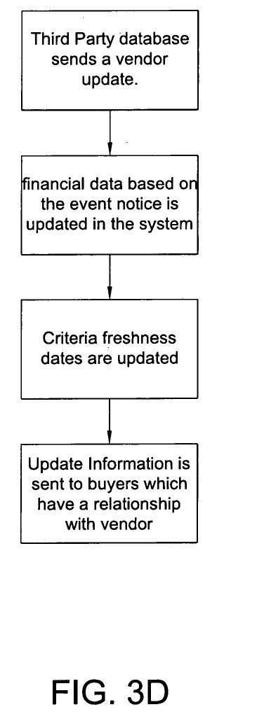

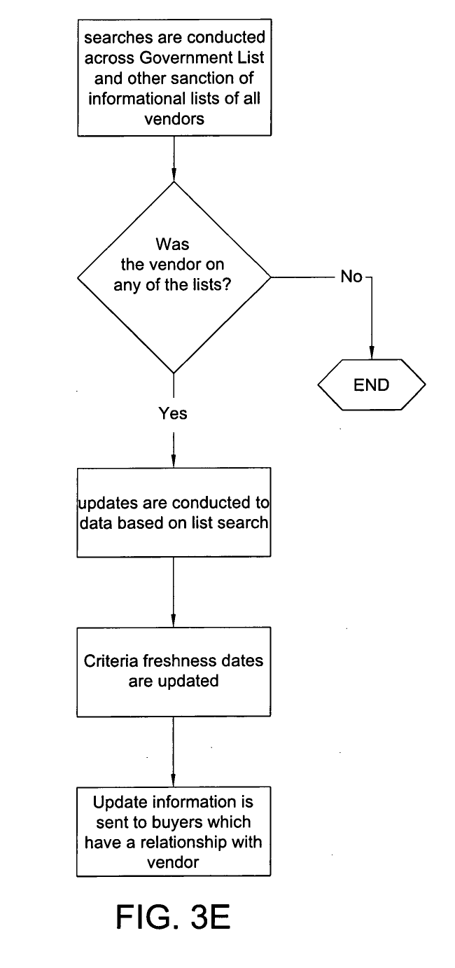

FIG. 3A is a flow chart illustrating steps involved in the registration of a previously unregistered vendor. In this embodiment, the vendor opens its browser to a buying organization's website (230). The vendor is then directed to a web page housed on a server of the present invention and enters pertinent information (240). Following confirmation of payment and registration, the vendor is provided login information and is queued for scoring and credentialing (250).

FIG. 3B is a flow chart illustrating a scenario wherein the system determines whether certain vendor information has been added or modified. In this example, the system determines whether compliance insurance information or diversity information has been modified (260). If yes, system refreshes to include updated or modified information.

Registration information from a vendor may also be received by uploading certificates of interest (such as diversity or insurance certificates) or by faxing such information. (See FIG. 3C).

In the present invention, information regarding a vendor is also received from third party databases. This information is then incorporated in the vendor's profile in the present invention. Such information includes, without limitation, financial information, such as is reflected in FIG. 3D. As a vendor's profile is updated with information received from third party databases, such information is available to buyers with whom the vendor has an established relationship in the system. Information is also obtained from third party databases such as governmental watch lists, as is reflected in FIG. 3E. This information is also made available to buyers with whom the vendor has a relationship within the system.

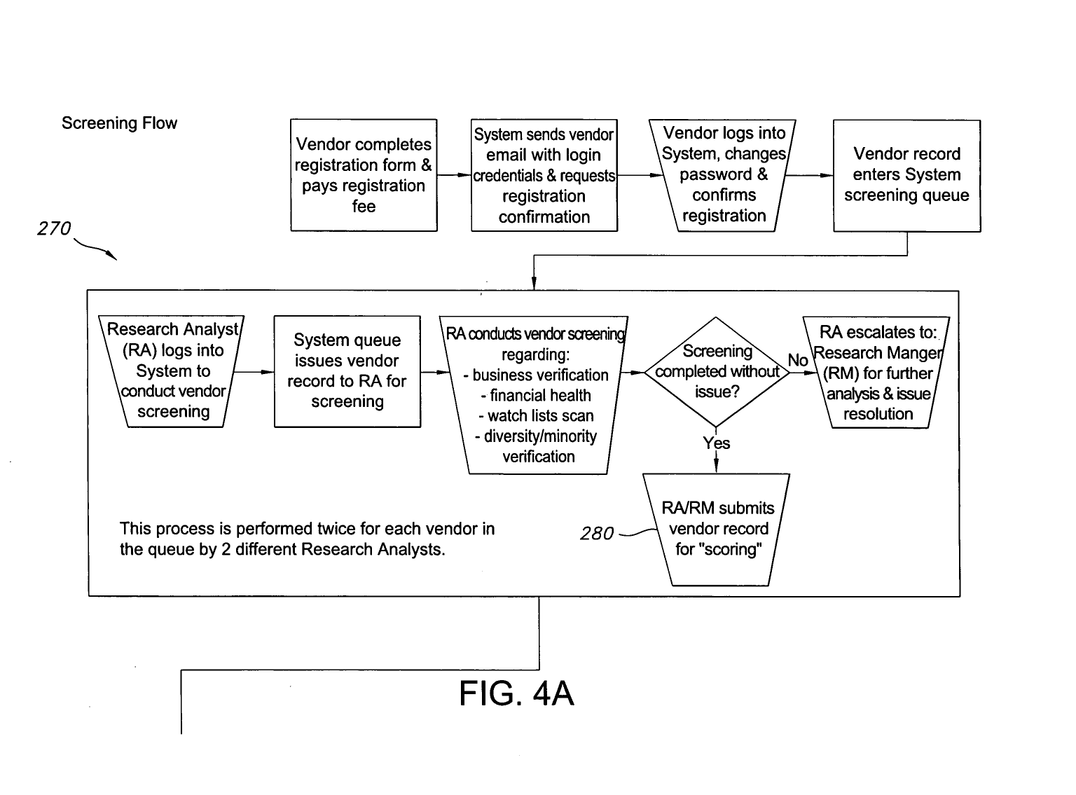

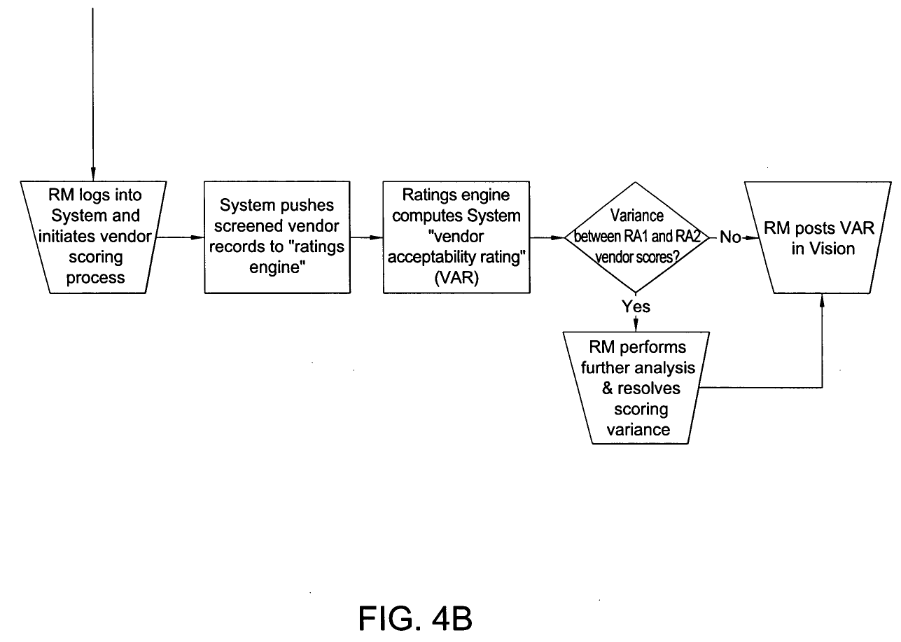

Depending on the current status of the vendor in the system of the present invention, the vendor either logs-in using a predetermined username and password or enters additional personal, organizational, cataloging, and/or diversity information to register with the system so as to obtain a username and password. Then, in order to be considered for purchasing by the buying organization, the vendor pays a subscription fee by credit card, electronic check, or other similar tool of electronic commerce using the computer interface or may remit payment via cash, check, money order, or other forms of payment. The subscription fee is for the use of the service of the present invention. As set forth in FIG. 4, a research analyst (“R.A.”) working on behalf of the operator of the present invention, in an on-demand fashion, then logs in to the server to conduct screening and analysis of the vendor (270). This screening may also be conducted electronically through pre-set criteria approved by the buying organization or a combination of “R.A” and electronic screening. Depending on the particular implementation agreed-to by the buying organization, third-party databases on hand and other third-party services are used in conjunction with the data provided by the vendor representative, for input into a scoring mechanism with a metric customized for a particulare buying organization (280). The score provided by this mechanism is then entered into the server. A buyer then logs in to the server using a predetermined username and password to view all vendors who have previously registered. A member of the buying organization then chooses one of several methods to locate a desirable vendor and views the answers previously provided by the vendor representative, selected third-party data details, and the customized score previously calculated.

In another embodiment, a vendor representative who desires to sell his products/services to the buying organization, from the web site of the buying organization, clicks a link to transfer his view to the server of the present invention. Alternatively, the vendor representative, referred by a member of the buying organization or an agent thereof by electronic or postal mail or by phone or similar method, enters the specific server locator address of the present invention into the representative's web browser or into a computer or fills out a paper form and faxes or mails that form with answers to a clearinghouse. If an electronic option is chosen, the vendor, as detailed below, enters his personal identifying information, and depending on the current status of the vendor in the system of the present invention, either logs-in using a predetermined username and password or enters additional personal, organizational, cataloging, and diversity information. This information may include information about the company's finances, labor relations, past or pending litigation, employee information, contact information, product information, insurance information, etc. The foregoing list is not meant to be exhaustive. If not already registered with the system of the current invention, to be considered for purchasing by the buying organization, the vendor pays a subscription fee by credit card, electronic check, or other similar tool of electronic commerce using the computer interface or may remit payment via cash, check, money order, or various other forms of payment. In another embodiment, the buying organization may partly or fully subsidize the cost of any or all of the vendors.

In one embodiment, a research analyst (“R.A.”) working on behalf of the operator of the present invention logs in to the server to conduct screening and analysis. In another embodiment, this screening and analysis in automated. Depending on the particular implementation agreed to by the buying organization, third-party databases on hand and other third-party services or in house information, are utilized in conjunction with data provided by the vendor representative for input into a scoring mechanism with a metric customized for this buying organization. The scoring mechanism will assign certain values for the information solicited from the vendor. The score provided by this mechanism is then transmitted to the server. A buyer then logs in to the server using a predetermined username and password to view all vendors who have previously registered. A member of the buying organization then chooses one of several methods to locate a desirable vendor and views the answers previously provided by the vendor representative, selected third-party data details, and the customized score previously calculated. The above is one embodiment of the present invention.

FIGS. 1A-1D illustrate an embodiment of the vendor registration component of the present invention. FIG. 1A illustrates the display of an exemplary web page requesting initial identifying information of the vendor and vendor representative. This sample web page may be customized with the logo, colors, and theme of the buying organization's primary web site. This example web page includes form fields for vendor representative name and email address and vendor name, doing-business-as name, business type, tax identifier number (Tax EIN or Social-Security #), and a third-party database identification number (i.e., a Dun & Bradstreet #). One skilled in the art would appreciate that these various fields can be rearranged, omitted, or adapted in various ways. In general, the system need only be able to identify the particular vendor representative and vendor from among other vendor representatives and vendors who may elect to use the system. In this embodiment, the vendor representative email address is expected to be unique to a single vendor representative, and the tax identifier number is expected to be unique to a single incorporated or otherwise identifiable vendor.

FIG. 1B illustrates the display of a web page requesting additional initial identifying information regarding the vendor and vendor representative. This example web page may be customized with the logo, colors, and theme of the buying organization's primary web site. Data from this sample web page is sent from the server system to the buying organization's system after the vendor representative submits the identifying information requested in FIG. 1A and after the server system has determined that an electronic entry for this vendor does not already exist in the server database. It is understood by one of ordinary skill in the art that such information may reside on a remote or in-house server. In this example, various fields are provided in a questionnaire including vendor identifying information; vendor description; vendor functions; founding and incorporation data; company principle names, titles, and tenures; vendor contact information; vendor sales capability (allowing the vendor representative to indicate to which cities, states/provinces, and countries the vendor is able to provide products/services); company financial data; company diversity data, in particular, questions about minority-owned, female-owned, small-disadvantaged-owned, and/or disabled-veteran-owned statuses and organizations certifying the vendor as such; electronic data interchange (EDI) capabilities; order-failure history; historical contract amounts; references; etc. One skilled in the art would appreciate that these various fields can be rearranged, omitted, or adapted in various ways. Many additional fields can be contemplated that would serve similar purposes to these. In general, proper questions must be asked to satisfy the buying organization in its desire to have a full concept of the existence, performances, qualities and abilities of the vendor. The fields on this questionnaire are adaptable to each buying organization's needs.

FIG. 1C illustrates the display of a web page requesting additional initial identifying information regarding the vendor representative. This example web page may be customized with the logo, colors, and theme of the buying organization's primary web site and is sent from the server system to the buying organization's system after the vendor representative submits the identifying information requested either in FIG. 1A or FIG. 1B (depending on whether the server system determined that an electronic entry for this vendor existed in the server database). In this example, various fields are provided in a questionnaire including vendor representative contact information; role explanation; sales territory (allowing the vendor representative to indicate to which cities, states/provinces, and countries the vendor representative is personally authorized to sell the vendor's products/services); and personal reference names and contact information. One skilled in the art would appreciate that these various fields can be rearranged, omitted, or adapted in various ways. Many additional fields can be contemplated that would serve similar purposes to these. In general, proper questions must be asked to satisfy the buying organization in its desire to have a full understanding of the existence and abilities of the vendor representative. The fields on this questionnaire are adaptable to each buying organization's needs.

FIG. 1D illustrates the display of a web page requesting that the vendor representative select the United Nations Standard Products and Services Code (“UNSPSC”) numbers describing that which the vendor is presently authorized to sell. This example web page may also be customized with the logo, colors, and theme of the buying organization's primary web site and is sent from the server system to the buying organization's system after the vendor representative submits the identifying information requested in FIG. 1C. In this example, the vendor representative selects to enter UNSPSC categories either specially requested by the buying organization (Simple Search) or anywhere within the UNSPSC specification (All Codes; Manual Code Entry). As the UNSPSC specification is hierarchical to four levels, in this embodiment, the vendor representative first clicks the “segment” to which the representative sells, after which a list of available “family” categories appears. When the representative clicks a particular “family” to which he sells, a list of available “class” categories appears. When he clicks a particular “class” to which he sells, a list of “commodity” categories appears. The vendor representative, can search for keywords or code number within the UNSPSC specification, then clicks particular commodity buttons to add that category to his list of “category codes” as indicated at the top of the page. One skilled in the art would appreciate that this particular layout and functionality can be rearranged or adapted in various ways. Most significantly, any number of commodity coding systems, either world or nation standardized or buyingorganization unique can be substituted or offered as additional options. Additionally, the particular interface techniques used to select category codes may be replaced with other graphical or textual software methods.

After completing the registration phase of providing information that is important to a given buying organization, the vendor representative pays a fee, in one embodiment, by an online credit card charge, though one skilled in the art would appreciate that many methods of payment could be contemplated including mailed or electronic checks, phone 900 charges, and electronic debiting accounts.

The block diagrams in FIGS. 2A and 2B indicate one embodiment of a logic process used to facilitate the registration and data entry by the vendor representative and illustrated, in part, by FIGS. 1A-1D. FIG. 2A illustrates the high-level process of a vendor representative arriving at the server hosting the software portion of the invention. In this example, “customer” refers to the buying organization and “actor” or “user” refers to the vendor. The vendor representative chooses whether to register as a new vendor or log-in to an existing vendor or vendor-representative account. As a new account, the vendor representative enters the basic information suggested by FIG. 1A. If the vendor does not exist in the system, information in FIGS. 1B-1D is asked of the vendor. Once a previously unregistered vendor completes registration information, the vendor is granted a unique username and password and the registration information becomes available to the buying organization through remote server or local network access. If the vendor is already a registered vendor, the vendor is prompted to enter its unique username and password. Upon confirmation, the vendor is allowed access to its account to manage and modify information to be submitted to the buying organization. As indicated by FIG. 2B, if the vendor exists in the system, the system checks to see if the vendor currently has a relationship with this customer (as opposed to a relationship with another customer also managed by the system of the present invention). Depending on that status, additional information or payment may be requested. In other words, it is contemplated that the system of the present invention includes a database of registered vendors wherein such vendors may be linked to one or more buying organizations. Such vendor-buyer relationships can be added, deleted or modified within the system of the present invention consistent with whether the vendor and buyer desire to do business with one another.

As indicated by the block diagram in FIG. 3, in this embodiment, data is input through the methods described above (or some other suitable manner, i.e., telephone, facsimile, etc.) FIG. 3(a) depicts a registration data entry scenario for a previously unregistered vendor. FIG. 3(b) depicts a scenario of login by a vendor that has previously registered with the system.

FIG. 3(c) depicts a scenario where information such as insurance or diversity status information is received by the system with respect to a previously registered vendor. In this scenario, the vendor's information is updated to reflect receipt of this additional information.

FIG. 3(d) reflects a scenario where information regarding a particular vendor is received from a third party database, such as a financial and/or credit scoring database, and is uploaded into the system of the present invention for purposes of refreshing a vendor's system profile.

FIG. 3(e) depicts a scenario where the results of vendor searches of governmental watch lists are updated into the system of the present invention and used to refresh vendor profile information.

FIG. 4 describes an embodiment of the credentialing and scoring process for the present invention. A data record is received from a queue once a vendor representative has completed the registration process. This data record is compiled along with information available from 3^{rd}-party sources such as business verification, financial health, government watch lists, customer policies, and diversity and insurance certification boards. It is to be understood by those of ordinary skill in the art that certain steps may be performed by an employee or automated. In any event, it is important that some level of redundancy be incorporated in the system so as to ensure accurate scoring results for any manual portions.

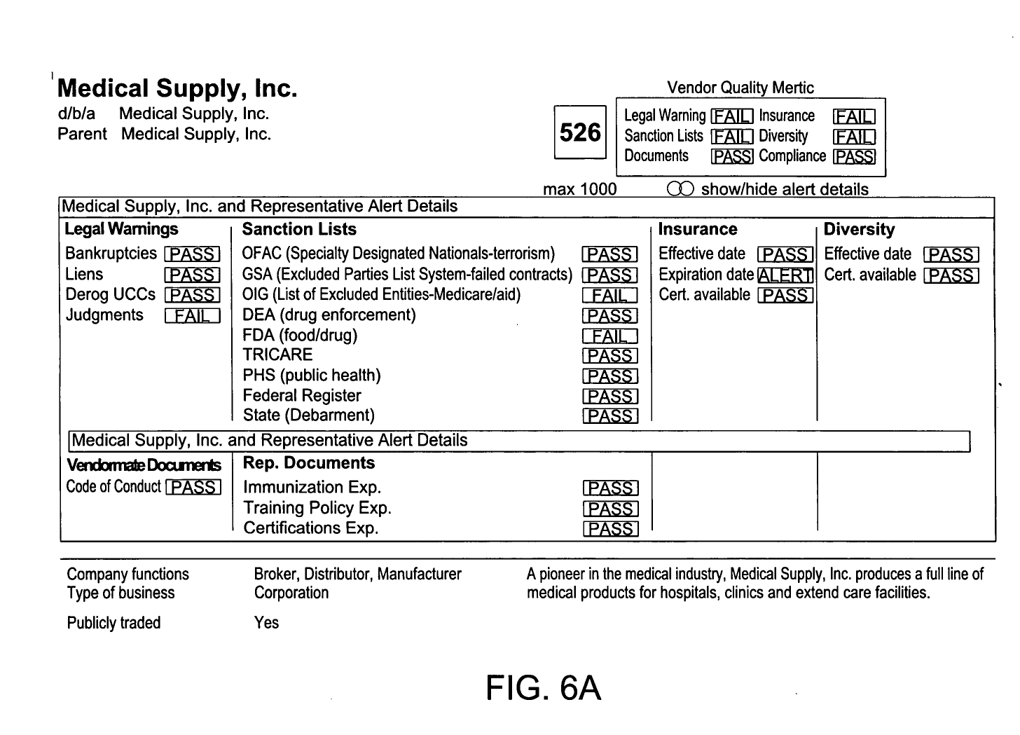

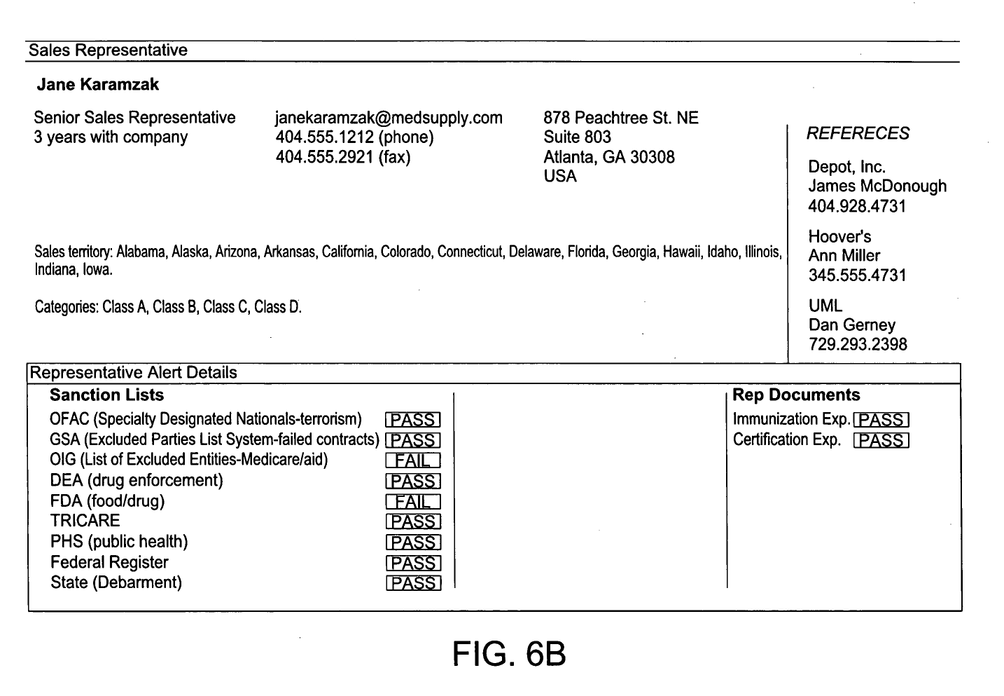

In one embodiment of the scoring system, data such as the following are used to rate an organization's risk: founding years; number of employees; office locations; government sanction or terrorism watch lists; balance sheet and income statement data; diversity statuses of the owners; legal claims such as bankruptcies, liens, judgments, and derogatory UCC recordings; insurance coverage; credit score details; criminal records; and “social scoring” mechanisms that gauge brand awareness. This should be considered neither an exhaustive list nor one that must be utilized in full, and one skilled in the art would realize that any number of data points regarding an organization and the key personnel of an organization may be utilized for scoring purposes. In one manifestation, once gathered, each data point is assigned a weighted value based on a particular client's needs (though, in other manifestations, this could be standardized across an industry, geographic area, buying organization, single buyer, or other system). The weight assigned to a give criteria is determined through input from the buying organization as to which criteria are most and least important to that buying organization. The reported data and weighted values are then analyzed to provide, in one manifestation, a single numeric score and a list of boolean fields that announce passage or failure of key data points. This information is then available to the buying organization to enable the buying organization to determine with a particular vendor is qualified to do business or remain doing with the buying organization. The system is configurable so that members of the buying organizations and vendor representatives can be notified and alerted as to changes in the vendor position in the system. (See FIGS. 6a-6b).

In one embodiment of the present invention, the vendor representatives are required by the buying organizations to digitally acknowledge or sign and submit policies and other documentation. Buying organizations may fully customize documents which the system will present to the vendor representatives during registration or subsequent entry into the system. They system will require digital acknowledgement by the vendor representatives if required by the buying organizations. If the buying organization policy requires, the system can provide the document to the vendor representative for signature. The vendor representative can import the signed document back to the system electronically or by other means of import. Vendors may also import non-required documents which are beneficial to the buying organization. Members of buying organizations may view all documents from the system for their vendor and vendor representatives. The system tracks meta data for each document as entered by the vendor representative or a member of the buying organization. The system notifies and alerts applicable vendor representatives and buying organization members as to events and changes to status of policies procedures and signature events. Notifications are customizable based on event so that the system is able to notify in advance the appropriate parties for issues such as expiration and effective dates, notification for termination, etc.

In one embodiment of the system, the buying organization may include a subjective rating with the objective scoring previously described. The subjective portion of the rating is based on opinion feedback metrics provided by members of the buying organization. The buying organization may implement standard or customized metrics for different buying groups, vendors, product offerings, etc. Members of the buying organizations are able to submit feedback metrics along with freeform comments on the vendor entity and the vendor representatives as they see fit or as they are required by their management. The system allows the buying organizations to view the subjective rating of the vendor entities and representatives based on buying organization, sub buying organization, and buying member. Trending analysis is available across the duration of the relationship between vendor and buying organization as well as between vendor representative and buying organization.

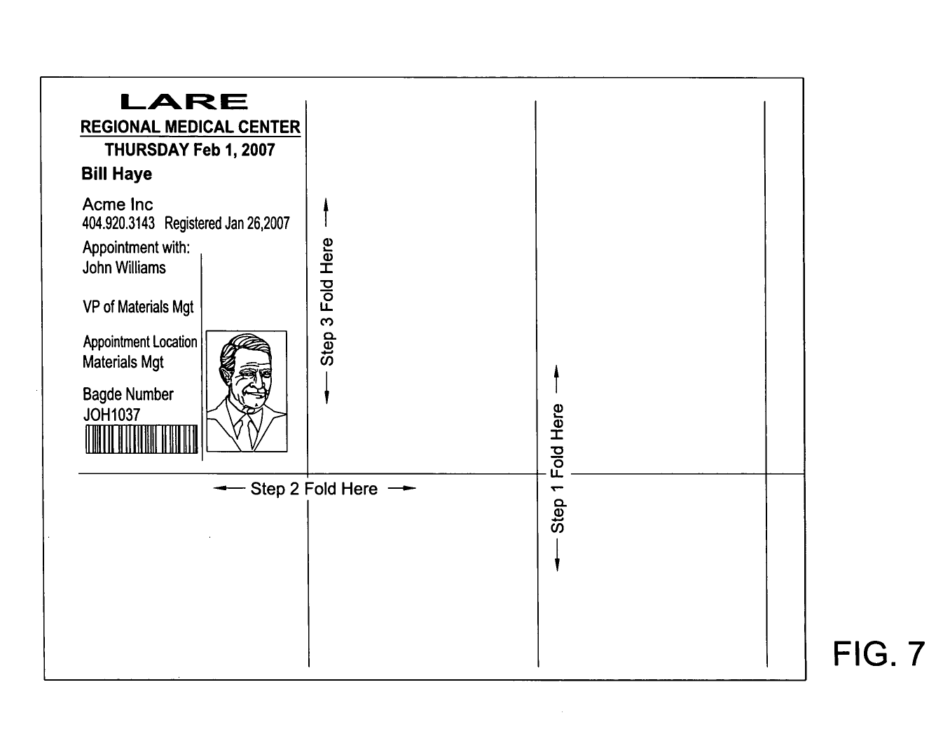

In the preferred embodiment of the system, the buying organization requires the vendors who are on premises to acquire a physical access credential. The system provides a fully integrated physical or logical access credential to the buying organization for use at locations of the buying organization. Vendor representatives are able to register their entry into the location of the buying organization. At that time, the system validates their status and via a rules based work flow, routes the vendor representative to the appropriate member of the buying organization. All vendor information, scores, alerts, and compliance information is available to the access credential as the buying organization requires. Vendor representatives are able to notify the system as to their exit from the buying organization premise. The system can track, report on, perform analysis on, and alert the buying organization an other users of the system as to vendor representatives behavior during the “sign-in/sign-out” process. Buying organizations may also require the vendor representatives to require approval through the system before an access credential is awarded. In this process, the vendor representative may request an appointment from a member or members of the buying organization. The member of the buying organization can approve, change, reject, etc. the request. Upon approval, the vendor representative may be granted the access credential based upon the best practice and policies of the buying organization. The physical access credential allows the buying organization to present other customized information to the vendor representative as well as system information pertinent to the specific representative (effective/expiration dates, status, news, policy changes, procedure changes, etc.). Those of ordinary skill in the art would recognize that the access credential in a logical form would be integrated to existing access credential systems of the buying organization. Existing systems could use any of the information within the system so as to manage, grant, or deny those access credentials. An example of a badge generated by the system to assist with on-premises visits from vendor representatives is set forth at FIG. 7. In this figure a hypothetical vendor representative named “Bill Haye” has an appointment with a hypothetical buying organization named “John Williams” who is the “VP of Materials Mgt” at a hypothetical buying organization representative named “LARE Regional Medical Center.” The badge may be folded along fold lines to fit neatly in a transparent holder (not shown).

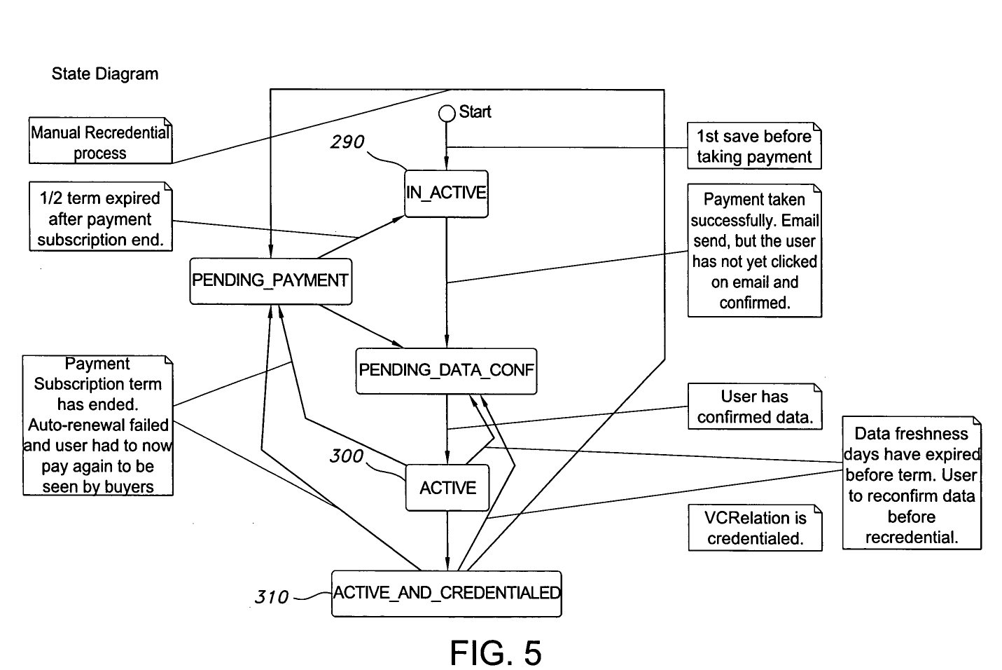

FIG. 5 indicates the different vendor data statuses contemplated by one embodiment of the invention. Upon registration, the vendor is listed in the system but is not “active” (or visible to other users in the system) (290). After a vendor representative confirms its data entry, the vendor is marked as “active” (300). Following the credentialing process such as that indicated above, the vendor is marked as “active and credentialed” (310). Whether a vendor is labeled active or inactive may also depend on the payment status of the vendor. In this scenario, if the payment subscription term has lapsed, the vendor's state changes to “pending payment” before ultimately being marked “inactive” if payment is not made within a suitable time. In this embodiment, active status is determined, in part, by whether the vendor has made appropriate payment to the system.

One skilled in the art would appreciate that the specific logic suggested by FIGS. 2-5 could be adapted, omitted, rearranged, or accented by additional decisions or steps as part of the spirit of the invention.

At any point, a member of the buying organization may log-in to the server hosting the invention to view all vendors currently visible to him. FIGS. 1E-1F illustrate an embodiment of these cataloging and data viewing abilities of the present invention. FIG. 1E further illustrates the display of a web page for a “buyer dashboard”. This example web page is sent from the server system to a member of the buying organization system after a member of the buying organization logged-in. This example web page may include sections showing recently subscribed vendors, personal and customer “common” product categories and providing access to all visible subscribed vendors through alphabetic and categorical means. One skilled in the art would appreciate that these various sections and abilities can be rearranged, omitted, or adapted in various ways. Many additional methods of retrieving saved vendor details can be contemplated that would serve similar purposes to these. In general, it is important that a buyer be able to easily locate a subscribed vendor to suit a member of the buying organization's needs.

FIG. 6a illustrates the display of a web page showing vendor details for a hypothetical vendor named “Medical Supply, Inc.” FIG. 6B illustrates the display of a sample web page showing vendor representative information for a hypothetical vendor representative named “Jane Karamzak.” These example web pages are sent from the server system to the client system after a member of the buying organization has navigated through the system to locate a vendor. It shows the vendor's score, and trending information, as credentialed in a process such as that embodied in FIG. 4 and most of the data collected from the vendor through a process such as that embodied in FIGS. 1A-1D. One skilled in the art would appreciate that these various sections and abilities can be rearranged, omitted, or adapted in various ways depending on the particular requirements of a member of the buying organization. In general, proper data must be displayed to satisfy the buying org anization in its desire to have a full concept of the existence and abilities of a particular vendor and its vendor representative.

Although the present invention has been described in terms of various embodiments, it is not intended that the invention be limited to these embodiments. Modification within the spirit of the invention will be apparent to those skilled in the art.

What is claimed is:

1. A method for administering a relationship between a vendor and buying organization comprising the steps of:
requesting information from the vendor;
receiving requested information from the vendor;
searching third party database for information related to the vendor;
receiving information from third party database regarding the vendor;
requesting information from a buying organization regarding vendor credentials required by the buying organization;
credentialing the vendor based on information received from the vendor and third party database;
classifying the vendor based on the credentialing results; and
providing vendor information and credentialing information to the buying organization.

2. The method of claim 1, wherein the information requested from a vendor comprises contact information, company information, sales representative information, product information, and financial information.

3. The method of claim 2, wherein the information received from a vendor is stored in a database storing information requested from other vendors.

4. The method of claim 3, wherein the information received from third party database is stored in a database storing information about the vendor.

5. The method of claim 4, wherein the credentialing is comprised of assigning weighted values to information received from the vendor and third party database.

6. The method of claim 5, wherein the buying organization provides preferences that determine weights assigned to information received from the vendor and third party database.

7. The method of claim 6, wherein the credentialing is comprised of a weighted average of information received from the vendor and third party database.

8. The method of claim 7, wherein the vendor credentialing is further comprised of compliance alerts.

9. The method of claim 8, wherein the credentials of a vendor are provided to a buying organization for assisting the buying organization in determining whether the vendor and buying organization will conduct or continue to conduct business with each other.

10. The method of claim 9, further comprising the step of requiring payment from the vendor.

11. A system for administering a vendor-buying organization relationship comprising:
an interface for receiving information requested from a vendor;
an application for searching third party database for information related to the vendor;
an interface for receiving information from third party database;
an interface for receiving vendor credential requirements of a buying organization;
a metric for credentialing the vendor based on information received from the vendor and third party database and vendor credential requirements of a buying organization;
a metric for classifying the vendor for the buying organization based on the credentialing metric; and
an interface for providing vendor information and credentialing information to a buying organization.

12. The system of claim 11, wherein the information requested from a vendor comprises contact information, company information, sales representative information, product information, and financial information.

13. The system of claim 12, wherein the information received from a vendor is stored in a database storing information requested from other vendors.

14. The system of claim 13, wherein the information received from third party databases is housed in a database storing information about the vendor.

15. The system of claim 14, wherein the credentialing is comprised of assigning weighted values to information received from the vendor and third party database.

16. The system of claim 15, wherein the buying organization provides preferences which determines weights assigned to information received from the vendor and third party database.

17. The system of claim 16, wherein the credentialing is a weighted average of information received from the vendor and third party databases.

18. The system of claim 17, wherein the vendor is categorized based on the credentialing of information.

19. The system of claim 18, wherein the categorization indicates a likelihood of whether the vendor and buyer will conduct or continue to conduct business with each other.

20. The system of claim 19 further comprising payment by the vendor.
